(19) United States
(12) Patent Application Publication
(10) Pub. No.: US 2002/0091797 A1
(43) Pub. Date: Jul. 11, 2002

(54) Method for providing a user interface to a subscriber terminal for configuring intelligent network services

(76) Inventors: Jukka Wallenius, Helsinki (FI); Sami Uskela, Helsinki (FI)

Correspondence Address: Francis J. Maguire, Ware, Fressola, Van Der Sluys & Adolphson LLP, 755 Main Street, PO Box 224, Monroe, CT, 06468, US

(21) Appl. No.: 10/010,924

(22) Filed: Dec. 7, 2001

Related U.S. Application Data
(63) Continuation of application No. PCT/EP99/04052, filed on Jun. 11, 1999.

(51) Int. Cl. G06F 15/16

(52) U.S. Cl. 709/218; 709/219

(57) ABSTRACT

A method for providing a user interface between a terminal device (MS) and a communication network (IN-NW) configures intelligent network services. The network (IN-NW) includes a service control entity (SCP) and a server entity (WAP-SERVER) communicating with each other via an interface (WAP-I/F). The SCP is connected to at least one service switching device (SSP) establishing communication via at least one access network (BSS) with the terminal device (MS). The MS is provided with a browsing means (WAP-UA) adapted to communicate with a user of the MS via a man machine interface (MMI) and with the WAP-SERVER. Content constituting a user interface is provided for the control of a multiple subscriber profiles (MSP) feature with the user interacting with the content. The state of the MSP is modified in accordance with the interaction.

### CROSS-REFERENCE TO RELATED APPLICATION

This application is a continuation of International Application PCT/EP99/04052 having an international filing date of Jun. 11, 1999 and from which priority is claimed under all applicable sections of Title 35 of the United States Code including, but not limited to, Sections 120, 363 and 365(c).

### BACKGROUND OF THE INVENTION

1. Field of the Invention

The present invention relates to a method for providing a user interface between a terminal device and a communication network for configuring intelligent network services. Particularly, the present invention relates to such an intelligent network (IN) supporting CAMEL (Customized Applications for Mobile network Enhanced Logic) and/or an MSP (Multiple Subscriber Profile) feature.

2. Discussion of Related Art

Recently, the development of mobile telecommunication and the services offered thereby has made large progress. Particularly, mobile telecommunication systems now also permit access to so-called intelligent peripherals or offer an access to the Internet. Additionally, with an increasing number of services offered, there also arises a need for an individual configuration, for each respective user of a terminal device such as a mobile station, of the various services available. Such an individual and personal configuration of services in turn necessitates a corresponding interaction between the user himself and the network.

It is to be noted that, throughout the present specification, CAMEL and IN designates any solution in which a call, connection or session processing node contacts a service control function which issues instructions to the respective node. The contact to the service control function is based on a trigger information stored in the respective nodes. The trigger information may specify situations in the course of a call, connection or session handling. The service control function may be internally distributed. Moreover, the corresponding IN protocol could be any protocol between a controlling entity, such as a service controller (e.g., CAMEL Service Environment, CSE), responsive to a triggering from a call, and a session or connection processing node. The IN protocol may be, e.g., an object oriented interface where the operations are object methods or invocations.

It is to be noted further that throughout the present specification, WAP and WTA designate any solution in which there is a content execution environment (user agent) at the terminal side and this environment is capable of controlling terminal (MS) functionalities such as call control, mobility management MM and user interface. Furthermore, the execution environment may receive content from the network spontaneously or it may be provided with references to content to be downloaded. The content may be hypertext, markup language code, any interpreted or even native or virtual machine code.

It is to be noted further, that throughout the present specification, MSP or subscriber profiles designate any solution, in which in association with the service control function there are alternative predefined service provisionings, setting configurations and billed parties which can be selected by the user without separately changing the individual settings and provisionings. The service control function implements these service profiles by differing service control depending on the profile selected and the service in the profile.

Currently, in intelligent networks (hereinafter also referred to as IN-networks), a user interaction is provided for by using in-band announcements and by relying on DTMF (Dual Tone Multiple Frequency) collection.

However, such procedures are often cumbersome and slow from a viewpoint of the user, especially in case the services are used frequently.

An alternative resides in the use of USSD (Unstructured Supplementary Services Data) based user interaction, but the problem with USSD is that USSD messages in itself without WAP content do not specify the formatting of the data to the user and the prompting. Similarly, with USSD more complex user dialogues are not possible. For instance, it is difficult for the user to enter multiple information elements at a time in one USSD response, e.g., the user would have to enter delimiters after each information element.

Moreover, in a release for future GSM (Global System for Mobile communications) standards in the year 1998, there is defined a feature called multiple subscriber profile (MSP). This feature enables a respective subscriber to have several sets of provisioned services and several subscriber telephone numbers for his terminal, so-called MSISDNs. A respective set of services is named a profile, and each profile is assigned at least one MSISDN. (A still further approach is to assign a respective MSISDN to each service feature of a profile).

The provisioning and the state of services is specific to a profile. For example, respective profiles can represent differently billed entities such as a company and a personal subscriber. Then, it could be possible for a user to select his company profile (defined by a profile identification or profile ID) when he is doing business calls, while he may select his private profile for effecting private calls.

The current working assumption in standardization on the implementation of the MSP feature is that it will be based on CAMEL.

However, up to now no proposal has been made regarding the implementation of a user interface for an MSP feature in a CAMEL network environment.

Independently therefrom, a WAP (Wireless Application Protocol) concept is currently being investigated. According to the concept of WAP, a browser means or so-called user agent is specified for a terminal device (e.g., mobile station MS). The browser means also supports a WTAI (Wireless Telephony Applications Interface), which enables WAP WML scripts (Wireless Markup Language scripts) as a kind of executable instruction sets or executable program, respectively, to interact with functions of the mobile station such as call control orientated functions. This means, that WML scripts receive event indications from a terminal and can request operations to be performed by the terminal. According to WAP, also applications are supported, according to which a WAP server at the network side providing some content to the terminal side browsing means (user agent) can push WML pages (comparable to HTML pages) (HyperText Markup Language) to the terminal, i.e., to the terminal's user agent.

However, currently the WAP concept was not defined in terms of providing a user interface between a subscriber terminal and an intelligent network.

### SUMMARY OF THE INVENTION

Consequently, the object of the present invention resides in the provision of a method for providing a user interface between a terminal device and a communication network for configuring intelligent network services which is free from drawbacks as discussed above.

This object is achieved by a method for providing a user interface between a terminal device and a communication network for configuring intelligent network services, said network comprising a service control entity (SCP, CSE) and a server entity communicating with each other via an interface, said service control entity being connected to at least one service switching device establishing communication via at least one access network with said terminal device, and said terminal device being provided with a browsing means adapted to communicate with a user of said terminal device via a man machine interface means, and adapted to communicate with said server entity, the method comprising the steps of: creating a content which constitutes a user interface for the control of a multiple subscriber profiles (MSP) feature; user interacting with the content; and modifying the state of the subscriber profiles in accordance with said user interaction.

Favorable refinements of the present invention are defined in the dependent claims.

More specifically, according to refinements of the present invention:

said state of subscriber profiles comprise the identity of the profile designated as the registered profile, and/or service states, and/or profiles selected for incoming or outgoing calls, and/or the execution states of each service;

the modifying the subscriber profiles state includes the selection of the profile to be used for an outgoing call;

the modifying the subscriber profiles state includes the selection of the profile to be used for an incoming call;

said services states comprise service activity/inactivity and/or service parameters for each service;

said content is loaded into said terminal device (MS) in response to a predetermined event;

said predetermined event is an IMSI attach, and/or a location updating, and/or a switching on of a new terminal for the user, and/or a subscriber profile registration request, and/or a supplementary service activation/deactivation request, and/or a terminal device originated call set-up request, and/or a terminal device terminated call set-up request;

said loading is effected from a subscriber identity module (SIM) to said terminal device mobile equipment part (ME);

said loading of said content is effected from a network element (WAPSERVER) to said terminal device mobile equipment part (ME);

said content is cached in said terminal device for later events;

said registered profile within the subscriber profiles state is maintained in the service control entity;

the selection of said registered profile is communicated to the service control entity by said browsing means;

the selection of said registered profile is communicated to the service control entity by the content issuing a USSD or SMS message to said network, the network communicating the registered profile to the service control entity;

the selection of said registered profile is communicated to the service control entity by the content issuing a WSP/HTTP post method (wireless session protocol/hypertext transfer protocol) to said network, the network communicating the registered profile to the service control entity;

said services states within the subscriber profiles state are maintained in the service control entity;

said services states within the subscriber profiles state are maintained partly in the service control entity and partly in the GSM registers (HLR, VLR);

a change in said services states is communicated to the service control entity by said browsing means;

a change in said services state is communicated to the service control entity by the content issuing a USSD or SMS message to said network, the network communicating the registered profile to the service control entity;

a change in said services state is communicated to the service control entity by the content issuing a WSP/HTTP post method (wireless session protocol/hypertext transfer protocol) to said network, the network communicating the registered profile to the service control entity,

the selection of the subscriber profile to be used for a terminated call is performed by issuing a content push to said browser means; user interacting with the content; selected subscriber profile indicated to said server entity;

the selection of the profile to be used for a terminated call is prompted from the user when the calling party dials a number not explicitly indicating the subscriber profile for the incoming call;

the modifying of the state of the subscriber profiles includes the control of the execution of each service

first the capabilities of the said terminal device (MS) and/or user agent capabilities are indicated to said server entity; the said content is selected on the said server entity based on the said capabilities; the said selected content is downloaded to the said terminal device (MS);

the capabilities of the said terminal device (MS) and/or user agent capabilities are indicated to said server entity If the mobile equipment part (ME) of the said terminal device has changed since the latest power off of the said terminal device (MS);

first said content is downloaded to said terminal device (MS), if it is discovered that such content is not already stored in said terminal device (MS);

information on the downloaded services is inquired from said terminal device (MS) and the downloading of said content is performed only if it is not among said downloaded services;

said content discovers the capabilities of said network when the user attaches to the network or enters the area of a new service switching device (MSC, SSP);

said content modifies the said user interface for the control of a multiple subscriber profiles feature in accordance with said capabilities of said network;

said capabilities of the said network is the Camel feature version supported in said current service switching device (MSC, SSP);

the capabilities of the said terminal device (MS) and/or browsing means are checked and compared to the capability requirements of said content before said loading; and if the capability requirements are not satisfying, downloading said content from said network.

Also, the present invention concerns a correspondingly adapted system for providing a user interface between a terminal device (MS) and a communication network (IN-NW) for configuring intelligent network services, said system being adapted to operate according to the method presented above.

With the present invention being implemented, it advantageously provides an easier method of configuring services in an IN network. Moreover, this simplification can directly be seen by the user of the terminal, who, in consequence, will be more willingly to configure the services he wants to use on his own. Additionally, this provides room for new services IN services which need to be configured by the user. For example, a configuration of a service may reside in turning on/off a service, inputting other subscriber information such as a subscriber status (at work (cf. “business profile” mentioned above), at home (cf. “private profile” mentioned above, on vacation, etc.). Likewise, by using the proposed interface, a subscriber may even be enabled to create services on his own.

### BRIEF DESCRIPTION OF THE DRAWINGS

The present invention is now described herein below in detail by way of example with reference to the accompanying drawings.

FIG. 1 shows a block diagram of a structure of an IN network;

FIG. 2 shows a signaling scenario in connection with an activation of MSP upon an IMSI attach as an event indication;

FIG. 3 shows a signaling scenario in connection with a registration of a profile in connection with MSP;

FIG. 4 shows a signaling scenario for an outgoing call with a profile different from the registered profile;

FIG. 5 shows a signaling scenario for an outgoing call including a signaling for confirmation of the profile identity;

FIG. 6 shows a signaling scenario for a standard supplementary service activation for a profile implemented using CAMEL;

FIG. 7 shows a flowchart which illustrates the overall procedure in setting of a profile of MSP at a flow chart level without detailing an involved signaling;

FIGS. 8A & 8B together show an additional signaling scenario according to the present invention for an MSP activation upon an IMSI attach;

FIGS. 9A & 9B together show a signaling scenario for a registration of supplementary services in a MSP environment according to a first way of implementation thereof;

FIGS. 10A & 10B together show a signaling scenario for a registration of supplementary services in a MSP environment according to a second way of implementation thereof;

FIGS. 11A & 11B together show a signaling scenario for the downloading of MSP menus according to an embodiment; and

FIGS. 12A & 12B together show a signaling scenario for a subscriber profile selection in case of an incoming call using WTA; particularly such a signaling scenario in connection with a mobile originated call in case a service user interface has not been downloaded to the terminal.

### DETAILED DESCRIPTION OF PREFERRED EMBODIMENTS

Hereinafter, the present invention is now described in detail with reference to the drawings.

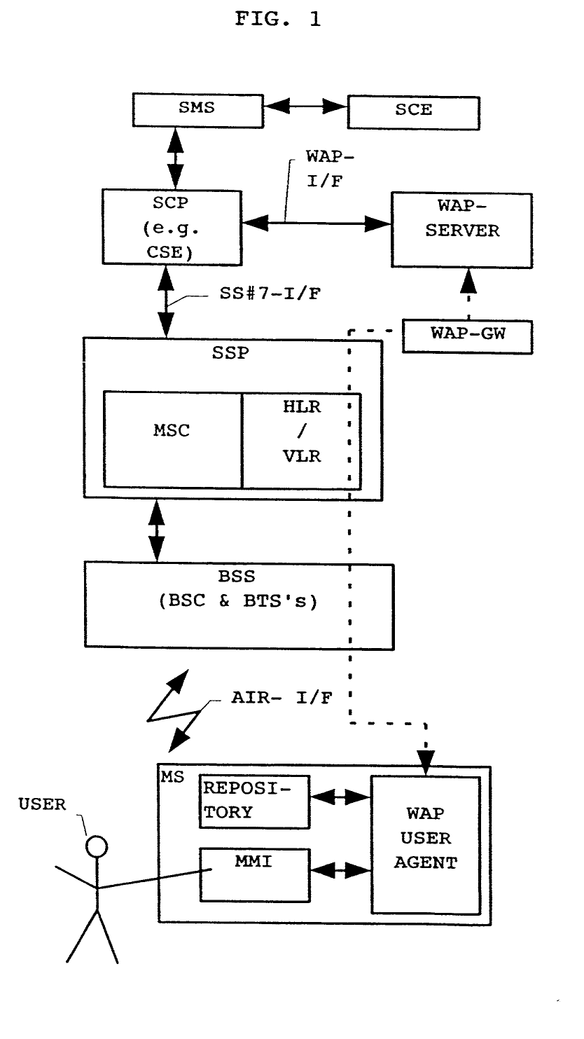

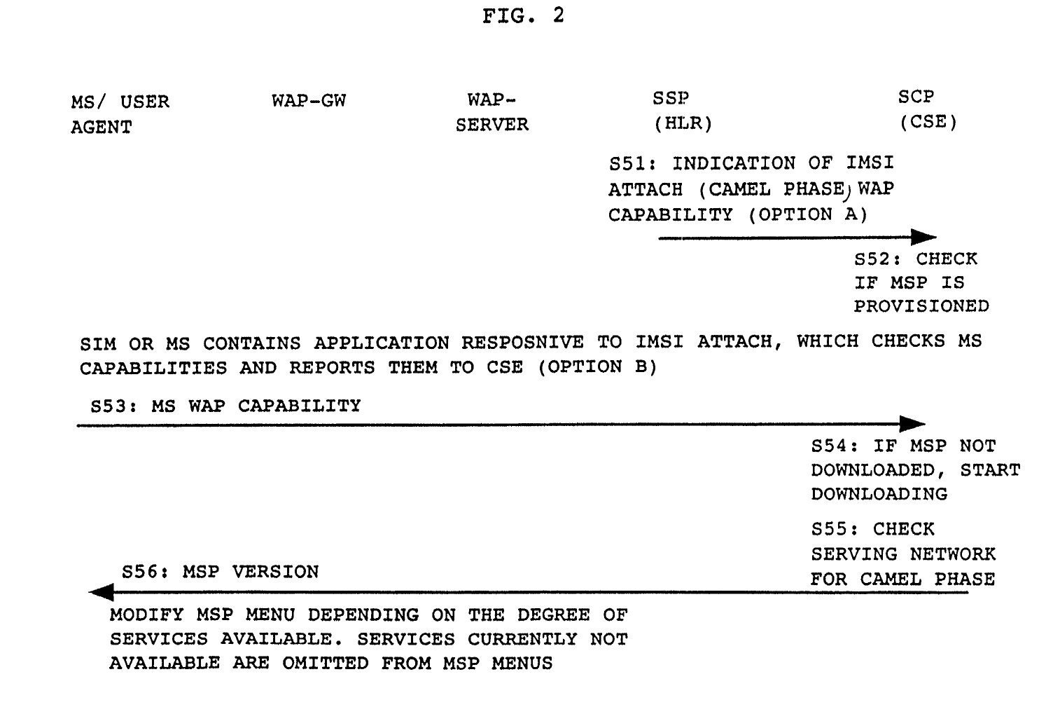

For still better understanding, the architecture of an intelligent network (IN network) is briefly described at first with reference to FIG. 1.

As shown in FIG. 1, an intelligent network as a communication network for intelligent network services comprises different IN network entities. For easier understanding, the following explanations omit the add-on of “entity” but rather refer to the network entities by their functional description. Also, as is current practice in standardization documents, the entities are referred to by using the abbreviation thereof after having been defined once.

Now, among these, a service creation environment SCE communicates with a service management system SMS. The SMS in turn communicates with a service control point SCP. In a CAMEL network environment, the service control point is also referred as CAMEL service environments CSE. Associated to the CSE, a WAP server is provided for, which is connected to the SCE vie a WAP based interface WAP-I/F. Although in FIG. 1 the WAP server and the CSE are illustrated as being separated from each other, they can be implemented in a single network node only, without necessitating any change to the present invention.

The SCP (or CSE in case of CAMEL) communicates via an interface SS#7-I/F adapted to the signaling system No. 7 with components of a PLMN network (Public Land Mobile Radio Network). Namely, the SCP communicates with a service switching point SSP. Such a SSP may be represented in a PLMN by a mobile switching center MSC, to which a home location register HLR and/or visitor location register VLR can be associated.

The MSC as a SSP communicates with a base station subsystem BSS consisting of at least one base station controller BSC controlling at least one base transceiver station BTS.

A respective BTS communicates via an air interface AIR-I/F with a terminal device such as a mobile station MS operated by a user.

More specifically, such a terminal MS, among other means (not shown) is, in connection with the present invention, provided with a WAP user agent or WAP browsing means, respectively. Generally, a user agent is any device adapted to interpret resources. The WAP user agent is adapted to communicate with the user via a man machine interface means MMI. Additionally, the WAP user agent is adapted to access a repository associated thereto. The repository is a persistent storage container as a kind of memory means storing WTA event catalogues and other pre-loaded WTA contents in connection with data used in connection with WAP.

Finally, the WAP user agent communicates (indicated by the dotted line in FIG. 1) by an intermediate WAP gateway WAP-GW with the WAP server associated to the CSE.

The communication path illustrated by the dotted line “passes through” the PLMN network, while however the information transmitted thereon are transparent for the PLMN network and can be regarded as being exchanged between the WAP gateway and the WAP user agent directly.

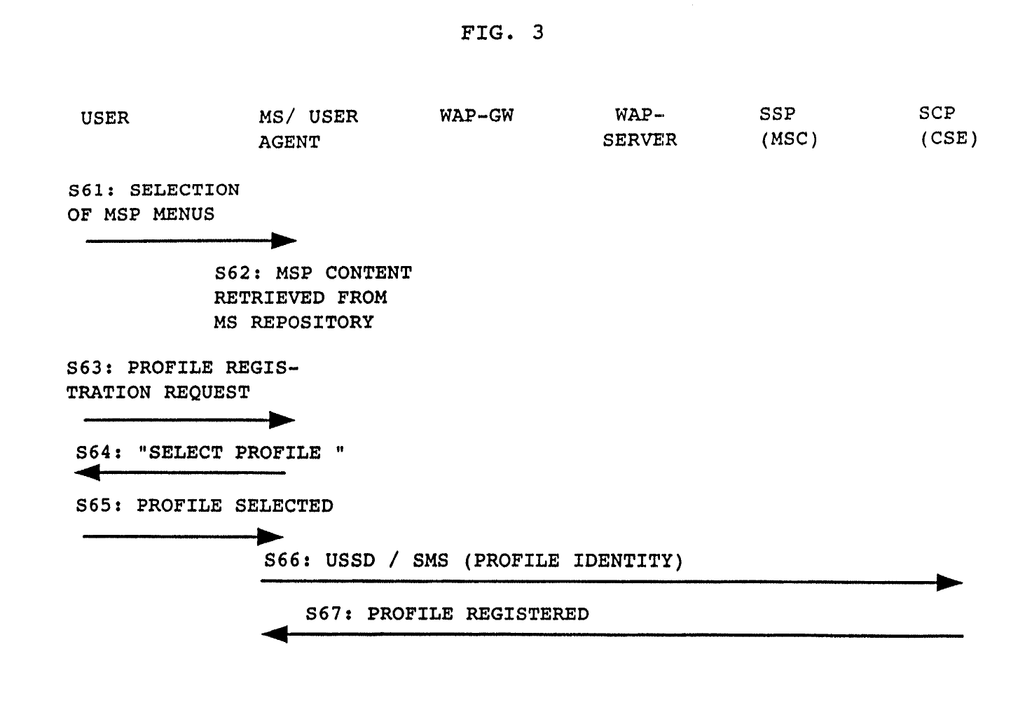

A corresponding signaling between the above introduced devices in order to implement and/or carry out the present invention will subsequently be described for different situations occurring in the network, with reference to FIGS. 2 to 12.

In these Figures, those components as briefly explained in connection with FIG. 1 are schematically shown with the corresponding signaling over time, i.e., signals communicated there between, being indicated as arrows.

When applied to the MSP feature of a CAMEL based network, according to the present invention, the implementation of an MSP user interface shall be based on the above briefly explained WAP concept and the use of the WTAI (Wireless Telephony Applications Interface). MSP menus and corresponding WML scripts are stored in a SIM (Subscriber Identity Module) card by the operator of the network, or they may be downloaded to the terminal in accordance with a method as explained in connection with FIG. 2. A corresponding WML script checks the support of CAMEL MSP features upon the detection of (predetermined) event indications such as for example location updates, etc. If MSP is supported by the network, corresponding MSP menus are activated in the WAP user agent. Furthermore, if subscriber profiles, i.e., MSP profiles, are to be managed, the MSP menus use WML URL methods to request/contact the WAP server, and the WAP server in turn interacts with the CSE network entity. The WAP pages and their WML scripts using WTAI enable the user interfaces to be defined for several MSP functions such as profile registration, explicit profile selection during call attempts and alternative profile service management etc.

Thus, the terminal checks (e.g., in connection with an occurrence of an event indication such as a network attach, a location update to a new location area, a subscriber profile registration request, or a supplementary service activation request) whether the network supports the CAMEL MSP feature. If this is the case, the MSP menus are activated in the WAP user agent (or downloaded thereto). The subsequent interactions towards the CAMEL CSE are effected using WAP substantially as described above.

Although herein above and subsequently, it is generally referred to WML scripts and URL and other associated terminology without going into detail, it is deemed that those skilled in the art perfectly understand the detailed technical meaning thereof. Hence, a full and detailed explanation thereof is considered to be dispensable, since the present invention will also become apparent to the reader without setting out every detail of WAP and WTAI.

Furthermore, it should be noted that currently supplementary services can be either standardized GSM supplementary services, which are based on service execution in the switches, or as IN based services. It must be noted that the following is applicable for any supplementary services which can be implemented either by service execution in the switches or as IN based. What is said about Camel versions is also applicable for the versions of any IN architecture such as American Wireless Intelligent Network (WIN).

If it is desired to have more than one subscriber profile, then some of the services have to be implemented as IN based, this is due to the fact that only one set of supplementary services and their associated data is supported by GSM registers and the GSM MAP signaling. However, currently only a subset of GSM supplementary services can be re-implemented as IN based. This leads essentially to two solutions in the implementation of multiple subscriber profiles. First solution is that one of the profiles contains standardized GSM supplementary services and the other profiles contain IN based variants of the same services. The second solution is that all the supplementary services that can be included in more than one profile are implemented as IN based, all the rest of the supplementary services shall be active according to their settings over all the profiles.

In either case, the when a user controls a supplementary service or manages the service data associated with the supplementary service, it must be known whether the service is IN based or standard GSM supplementary service based. If it is desired to hide from the user the fact whether in the current registered profile, in which a given service is managed or controlled, the service is IN based or GSM supplementary service based, the WML content must know how the service is implemented and provide an interface that hides this fact. This means that when receiving user input, the WML content deduces depending on the information on the current registered profile, which service management or control procedures must be applied. The management and control procedures can be the sending of unstructured messages (USSD, SMS or WSP post method) in the case of IN based services and standardized GSM SS service control and management procedures in the case of GSM SS based services.

When different versions of Camel are supported in different networks, the set of services that can be included in the alternative subscriber profiles are different, because the set of IN based services is different. In a given Camel version a service can be implemented as IN based, but in the earlier versions it cannot. This means that the WML content must be aware of the Camel version so that it can be known which of the services can be in more than one profile and which are independent of the profiles or alternatively which of the IN based services in the alternative profiles are available. This effect of the Camel version on the available services and on the providing of services in more than one subscriber profile shall be called hereafter the MSP version. This means that when receiving user input, the WML content must also check the MSP version to deduce which service management or control procedures must be applied.

Depending on the Camel version, different user interfaces can be presented by the WML content to the user. In an embodiment of the invention, the services that are supported as IN based are shown in association with more than one subscriber profile. Preferably, there can be sub-menus for each of the different profiles and a sub-menu for the rest of the services not included in the different profiles. The services not included in the different profiles shall be active or inactive according to their own settings over all the different profiles. In this way they are independent of the different profiles. Depending on the Camel version the amount of the services in the sub-menus for the different profiles may vary. Similarly, depending on the Camel version the amount of the services in the sub-menu for the services not included in the profiles may vary. When a service is not available as IN based to be included in the different profiles, it can be moved to the sub-menu for the services independent of the profiles. Alternatively, the services not available as IN based are just marked as not applicable in the sub-menus for the different profiles. The user may be instructed to use the generic service, which is in effect over all the profiles.

In the following, a description is given of cases, in which the WAP/WTAI principle method and/or functionality is used in connection with the CAMEL MSP feature as an example. It should be noted that the details of the interaction between the WAP server and user agent are, for the above reason, not explained in every detail in connection with the following description of FIGS. 2 to 7.

FIG. 2 shows a signaling scenario in connection with an activation of MSP upon an IMSI attach as an event indication.

In this case, two options are conceivable and therefor to be distinguished from each other.

According to option A, in a step S51, an indication of an IMSI (International Mobile Subscriber Identity) attach is forwarded from a home location register HLR as a part of the service switching point SSP of the network to the CSE. This indication includes, for example, the CAMEL phase and the attaching terminal's WAP capability (WAP capability being often also referred to as terminal MS capability). At the CSE, in step S52, it is checked whether the network provisions and/or supports MSP. (Also, the CSE may check from a MExE server (not shown in FIG. 1) as an entity caching MS terminal capability information, the terminal capability information cached.) According to option B, however, a subscriber identity module SIM or the terminal MS itself contains an application (e.g., WML script) which is responsive to an IMSI attach as an event indication, and which checks the terminal's MC capabilities and reports them to the CSE, as indicated in step S53. (Also, in connection with the MExE server alternative mentioned above, the step S53 may be replaced by an indication to the CSE from the MExE server as soon as MS terminal capabilities are obtained from the MS to the MExE server.) In a subsequent step S54, the CSE checks for the MSP service being downloaded, and if this is not the case, downloading of the MSP service to the terminal station, namely to its user agent is initiated. Then, in a step S55, the serving network is checked in regards of the CAMEL phase or CAMEL version it supports, and in step S56 the corresponding MSP version is reported from the CSE to the user agent.

Then, the MSP menu is modified depending on the degree of services available (determined by the MSP version), while services currently not available (in the current MSP version) are omitted from the MSP menus. Alternatively, the services not supported in the current environment are indicated as not applicable in the current environment, e.g., by dimming the text color or modifying the font otherwise for the selections associated with the services. In an embodiment of the invention, the user observes different services under profile based management and control depending on the MSP version supported. This means that in one MSP version a given service can be included in the different alternative profiles while in another MSP version the service can only be generic which means that its status, settings and control are independent of the profile selected. The following user-network interaction (not shown in this figure) is essentially in line with the WAP/WTAI principles mentioned earlier before.

It is to be noted that the entity capable of downloading MSP menus to the terminal MS is provided with the indication of MS terminal capabilities after activation of a new terminal, e.g., during location updating. Also, step S55 could be before step S54, if the whole MSP menus code is different per MSP version (which is enabled by present CAMEL phase). The description has been made under the assumption that within the downloaded menu code there is parameterisation, which may alter the menus downloaded depending on the MSP version. For example, some menu selections could be dimmed and thus be not available for selection, if the service to be specified thereby is not available.

FIG. 3 shows a signaling scenario in connection with a registration of a profile in connection with MSP. In a step S61, a user forwards a command for selection of MSP menus to the user agent. At the user agent, in step S62, an MSP content is retrieved from a terminal repository. Then, the user forwards (via the MMI shown in FIG. 1) a profile registration request to the user agent. The user agent acknowledges this request by transmitting, step S64, a “select profile” indication to the user, indicating that a selection of a profile is now possible. In step S65, the user selects a profile and the selected profile is informed to the user agent in form of a transmitted profile identity of profile ID. The user agent then transmits the profile ID in step S66 as a USSD/SMS message (Unstructured Supplementary Data/SMS) to the CSE, and the CSE as the SCP, in step S67, returns a message indicating that the profile is registered to the user agent.

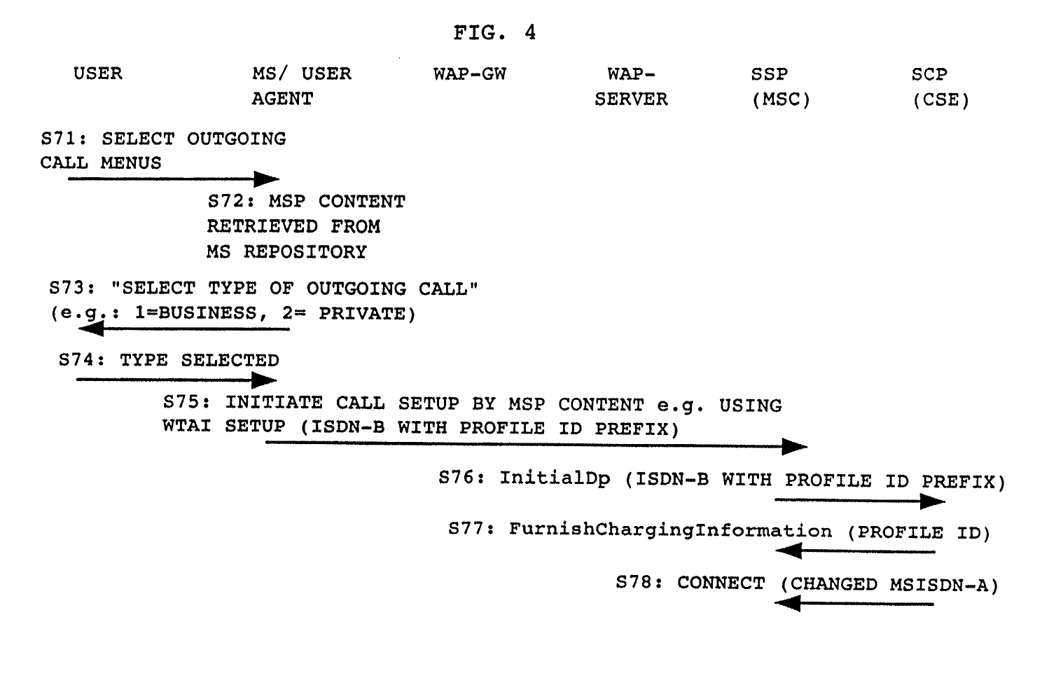

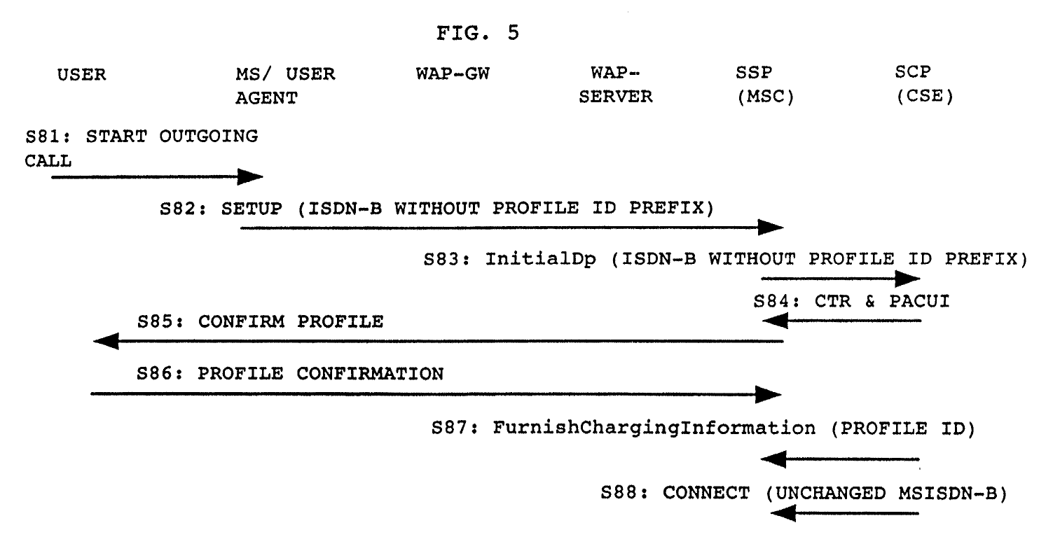

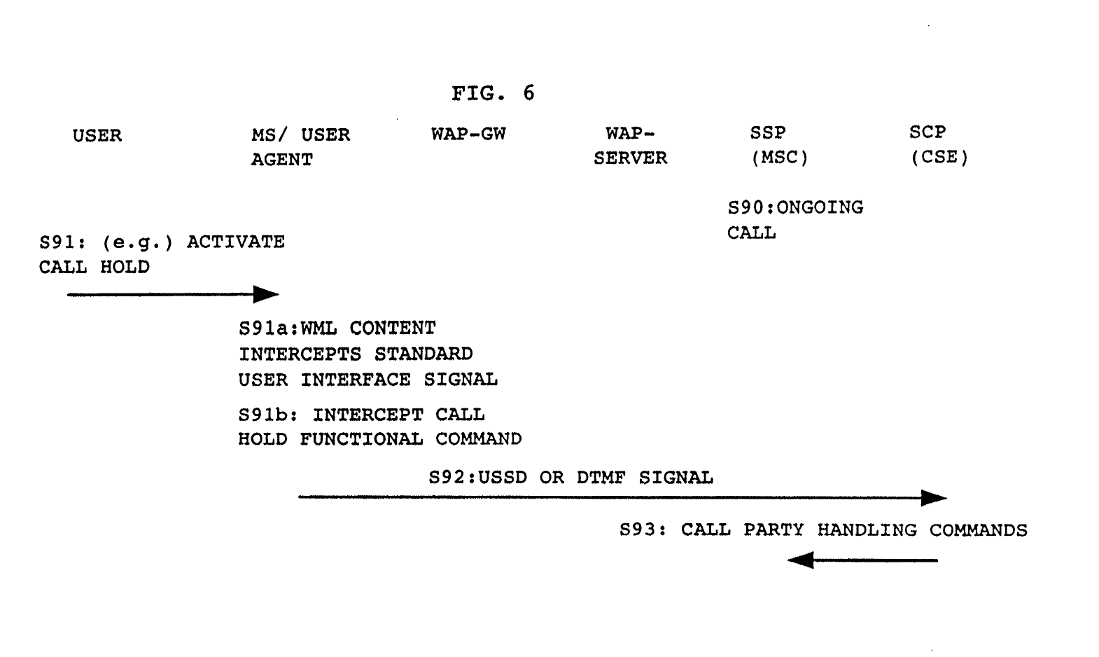

FIG. 4 shows a signaling scenario for an outgoing call with a profile different from the registered profile.

For the subsequent explanations, it is assumed that the MSP feature is defined as comprising two different profiles, which are distinguishable by the respective MSISDN number, namely a first profile (e.g., Profile ID=1) being assigned an MSISDN-A comprising business call service features, for example, and a second profile (e.g., Profile ID=2) being assigned an MSISDN-B comprising private call service features, for example. Further, the profile 2 (MSISDN-B) is assumed to be the registered one.

Then, the flow proceeds as follows. In a step S71, the user selects menus for an outgoing call at the user agent. At the user agent side, in a step S72, the MSP content is retrieved from the terminal's repository, and in step S73, an invitation to the user to select a type of an outgoing call such as business call (type/ID 1) or private call (type/ID 2) is forwarded from the user agent. The user in turn selects a desired type (here, according to the illustrated example, he selects type 1 (MSISDN-A)) and the information of the selected type is forwarded in step S74 to the user agent. It must be noted that a currently selected user profile can also be stored to the ME/SIM. This means that it is possible for the MS/User Agent to explicitly indicate the profile used in each outgoing call set-up information, e.g., in a called party number-prefix. This provides the advantage that the current profile does not necessarily need to be registered to the network.

Subsequently, the user agent, in step S76, initiates a call setup by an MSP content such as for example by using a WTAI setup message including the MSISDN-B as the MSISDN of the (according to the above assumption) registered profile together with a profile ID prefix of the selected profile. This setup message is transmitted to the MSC as a service switching point. In step S76, the MSC transmits an InitialDp message including the MSISDN-B together with the profile ID prefix of the selected profile type to the CAMEL service environment CSE. In step S77, the CSE returns a FurnishChargingInformation message to the MSC based on the profile ID of the prefix, and in a subsequent step S78 issues a connect command to the MSC based on the changed MSISDN, i.e., on MSISDN-A. Thus, the selected profile has, for this case of a specific call, replaced the registered profile.

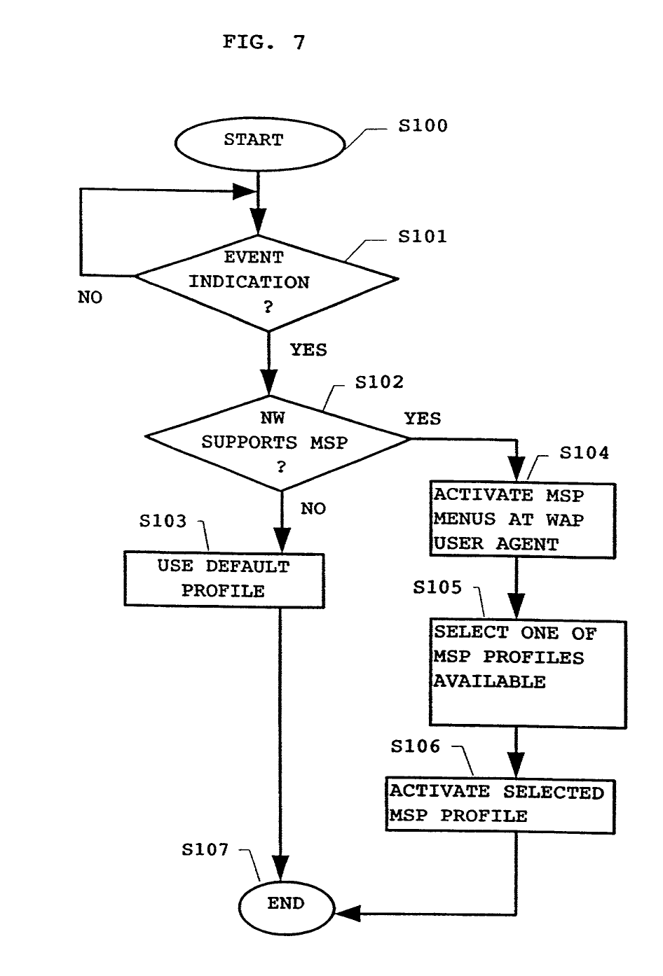

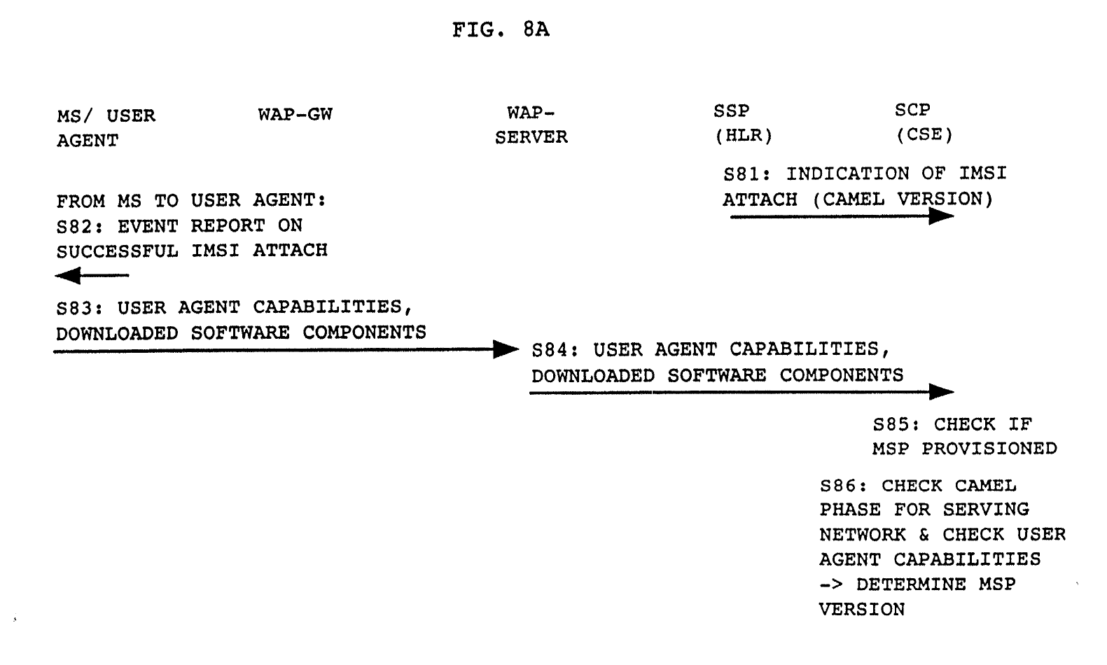

FIG. 5 shows a signaling scenario for an outgoing call including a signaling for confirmation of the profile identity. The same assumptions as made above in connection with FIG. 4 hold for this case.

In step S81, the user starts an outgoing call by forwarding a corresponding instructions to the user agent. The user agent in step S82 forwards a setup message/instruction based on the registered profile (MSISDN-B) without a profile ID prefix to the MSC. Again, the MSC forwards, in step S83, an InitialDp message, including said MSISDN-B but without a profile ID prefix, to the service control point CSP (CSE). In response thereto, in step S84 the CSE returns a ConnectToResource CTR command and PlayAnnouncementCollectUserInformation PACUI command to the MSC. In order to collect user information, the MSC transmits to the user an invitation to confirm the profile (step S85). The user responds in step S86 by a profile confirmation message transmitted to the MSC, and the SCP-CSE returns a FurnishChargingInformation message to the MSC based on the (thus confirmed) profile ID (step S87). Thereafter, the CSE issues a connect command to the MSC based on the unchanged MSISDN, i.e., on MSISDN-B, representing the (registered) confirmed profile.

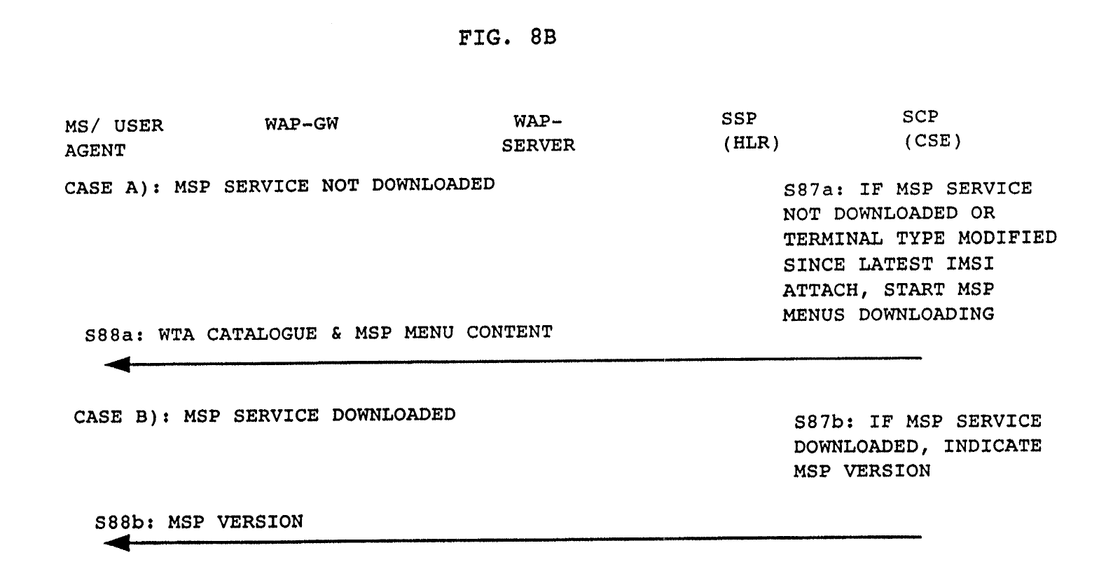

FIG. 6 shows a signaling scenario for a standard supplementary service activation for a profile implemented using CAMEL. In a step S91, a user activates a standard supplementary service such as for example a call hold service. This activation signal is transmitted to the user agent, at which in a step S91a, the WML content of a corresponding WML script intercepts a standard user interface signal, and in step S91b, a call hold functional command is intercepted. Then, in step S92, a corresponding USSD or DTMF signal is forwarded to the service control point, which returns in step S93 call party handling commands to the MSC as a service switching point, so that the call is held.

The WML content can be deduced based on the currently supported version of MSP feature, i.e., whether the supplementary service is available as a standardized version or as a CAMEL based service. Depending on this deduction, it can issue either the GSM supplementary service activation command to the MSC or the USSD/DTMF based activation command intercepted to the CSE.

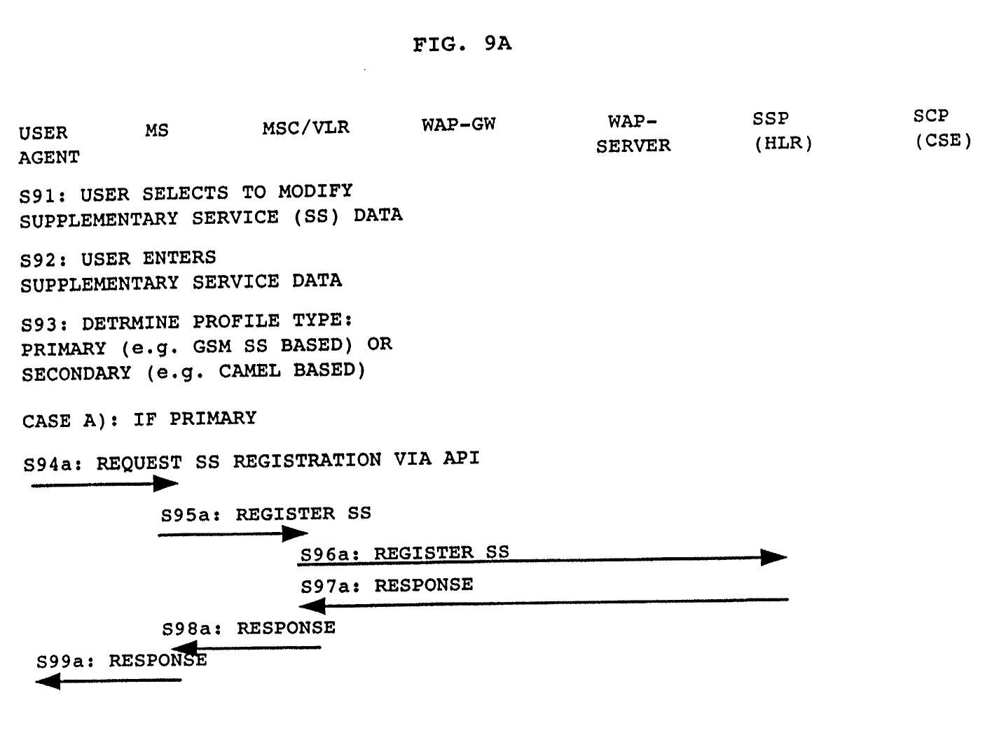

FIG. 7 shows a flowchart which illustrates the overall procedure in setting of a profile of MSP at a flow chart level without detailing an involved signaling.

The process starts in step S100. In a subsequent step S101 it is checked for the occurrence of an event indication such as, for example, an IMSI attach or location area update. If no such event indication is present (NO in step S101), the flow returns and loops until an event indication is present (YES in step S101).

If the loop is ended, the flow proceeds to step S102, in which it is determined if the network to which, e.g., the terminal attaches, supports the MSP functional feature. If the network does not support MSP, the flow proceeds to step S103, according to which a default profile is to be used for the further process and/or call and the flow ends in step S107.

If, however, it is determined in step S102 that the network NW supports MSP (YES in step S102), the flow branches to step S104 and the MSP menus are activated at the WAP user agent. Thereafter, the user may select one of available MSP profiles in step S105. (If no selection is performed, this has to be regarded as the selection of the default profile). In step S106, the previously selected profile is then activated and the terminal and network communicate with each other using the selected profile. The flow then ends in step S107.

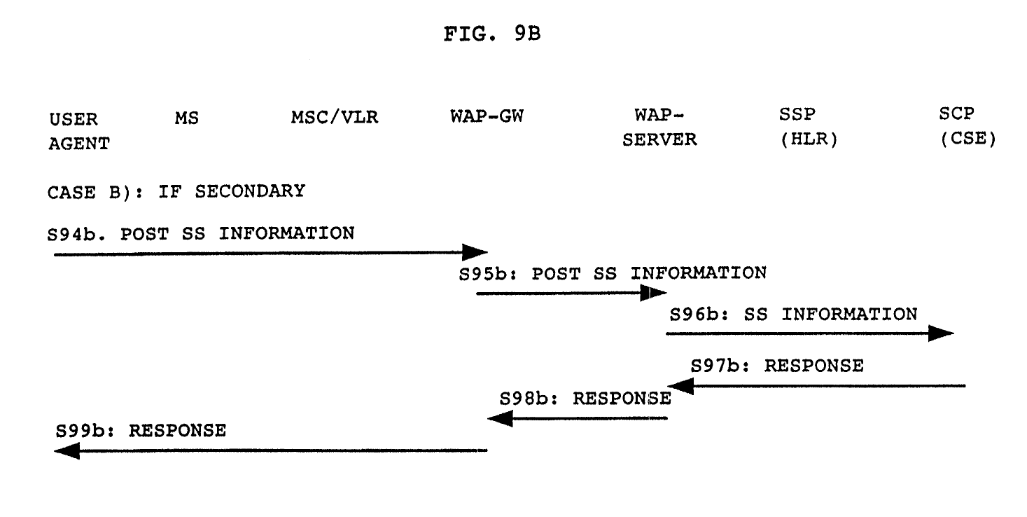

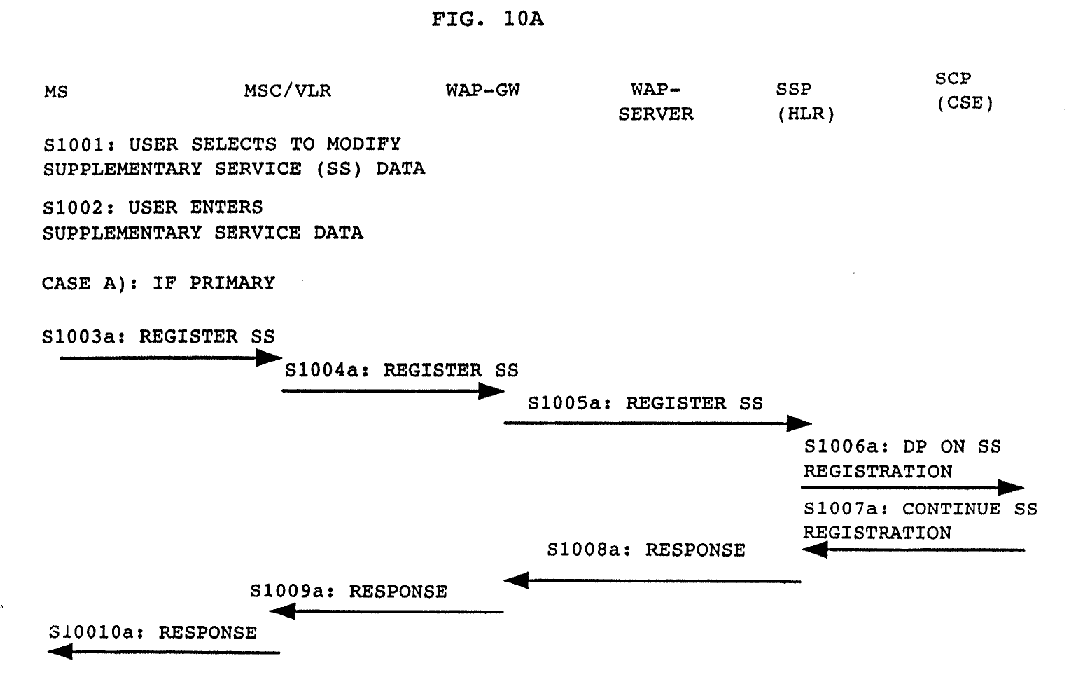

FIGS. 8A and 8B together illustrate an additional method for MSP activation upon detection of an IMSI attach as a predetermined event.

In a step S81 as shown in FIG. 8A, the HLR forwards an indication of an IMSI attach to the CSE as a SCP. In case of a successful attach procedure, the terminal MS forwards, step S82, a corresponding event report to the user agent associated thereto. Subsequently, the user agent capabilities and downloaded software components are forwarded and informed to the WAP server, step S83. The information on downloaded software components may also be indicated to the CSE via the WAP server separately. The WAP server in step S84 relays this information to the CSE as the service control point, which, in a follow up step S85, checks if MSP is provisioned or not. In a subsequent step S86, the serving network is checked in terms of which CAMEL phase it supports and the user agent capabilities are checked. (Note that steps S85 and S86 are performed at the CSE side.) As a result, the MSP version is determined.

At this stage of the method, the flow branches and two cases have to be distinguished as shown in FIG. 8B.

According to a case A, the MSP service is assumed to be not already downloaded to the terminal's user agent. Then, in a step S87a, if the MSP service is not downloaded, or if the terminal type was modified since the latest IMSI attach, the downloading of the MSP menus is started. In consequence, in a step S88a, a WTA catalogue and the MSP menu contents are downloaded from the CSE to the MS and/or its user agent.

According to a case B, the MSP service is assumed to be downloaded. Then, in a step S87b, if said MSP service is already downloaded, the MSP version is indicated and the corresponding version information is forwarded from the CSE to the terminal and/or user agent, respectively, as illustrated by step S88b.

This embodiment is optimal, if there is an automatic client capability report implemented from the WAP user agent/an MExE environment (not shown) to the WAP server/MExE server (not shown).

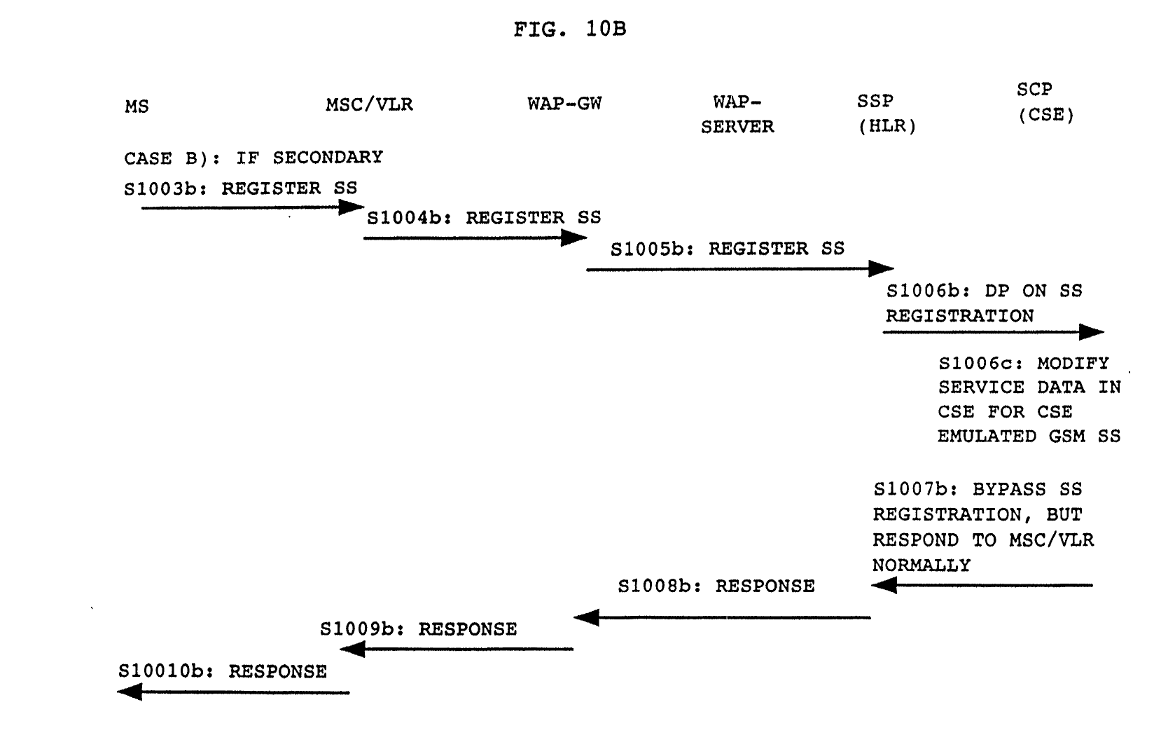

FIGS. 9A & 9B together show a signaling usable for the registration of supplementary services (SS) in an MSP environment according to a first implementation.

In a step S91, as shown in FIG. 9A, a user selects to modify supplementary service data (SS data), while in a following step S92, he/she enters (modified) SS data. In a subsequent step S93, a determination takes place at the user agent side as to which profile type is determined by these data. Namely, in the illustrated case it is distinguished between a standard profile (e.g., a GSM SS based one) or an IN based service profile, i.e., a CAMEL based profile.

It is also possible that the services included in the user profiles are CAMEL based while the services independent of the user profile registered are standardized GSM supplementary service based. The degree of services supported as CAMEL based depends on the MSP version supported in the current environment. Anyhow, it is determined, depending on the profile selected and the MSP version supported, whether a given service is GSM SS based or CAMEL based.

Depending on this determination, two different cases have to be distinguished.

In a case A (still depicted in FIG. 9A), in which a standard profile has been determined, in a step S94a, a request for SS registration is forwarded from the user agent to the mobile station via an API (Application Programming Interface). Then, in the subsequent steps S95a, S96a, the command to register the SS data is forwarded from the terminal MS via the MSC/VLR to the HLR. Upon registration thereof at the HLR, the HLR returns a response, step S97a, to the MSC/VLR, which response is relayed via the MS (step S98a) to the user agent again (step S99a).

In a case B, as shown in FIG. 9B, different steps are carried out in the profile type is an IN based service profile. Then, in a step S94b, SS information is posted from the user agent to the WAP gateway, and from there (step S95b) to the WAP server, which forwards the information (step S96b) to the CAMEL service environment CSE. The CSE sends a response (step S97b) to the WAP server, which forwards the same to the WAP gateway (step S98b), which sends the response back to the user agent (step S99b).

With such an implementation, the user interface hides from the user the fact whether the current profile is a standard one, in which the services are standard GSM supplementary services, or whether the current profile is a IN based one, in which the services are implemented using CAMEL.

FIGS. 10A and 10B together show signaling usable for the registration of supplementary services (SS) in an MSP environment according to a second implementation.

In a step S1001, as shown in FIG. 10A, a user selects to modify supplementary service data (SS data), while in a following step S1002 he/she enters (modified) SS data.

In a subsequent step (not shown) similar to step S93, a determination takes place at the user agent side as to which profile type is determined by these data. Namely, in the illustrated case it is distinguished between a standard supplementary service profile (e.g., a GSM SS based one) or a IN based supplementary service profile, i.e., a CAMEL based profile.

Depending on this determination, two different cases have to be distinguished.

In a case A, if the service profile is determined to be of a standard type, the MS registers SS data in a step S10003a to the MSC/VLR, which in a step S1004a in turn registers the SS data to the WAP gateway. The WAP gateway in a step S1005a registers the SS data to the HLR. The HLR functions as a detection point DP on SS registration and informs the CSE accordingly (step S1006a). In response thereto, the CSE forwards in a step S1007a an instruction to the HLR to continue registration of SS data. The HLR then sends a response to the WAP gateway (step S1008a), which forwards the response, in step S1009a to the MSC/VLR, which in turn informs the terminal MS of the response (step S10010a).

If, however, a profile of IN based type is present (case B in FIG. 10B), the terminal MS forwards a SS registration request in step S1003b to the MSC/VLR, which transmits the same in step S11004b to the WAP gateway. The WAP gateway relays the request in step S1005b to the HLR. Similarly as in case A, the HLR acts as a detection point DP on SS registration and informs the CSE accordingly. The CSE in step S1006c then modifies service data in the CSE for the CSE emulated GSM SS data. In step S1007b, the CSE instructs the HLR to bypass or suspend SS registration, but still to respond to the MSC/VLR as normal. A corresponding response is then transmitted from the HLR to the WAP gateway (S1008b), from there top the MSCVLR (S1009b), and from there to the MS (step S10010b).

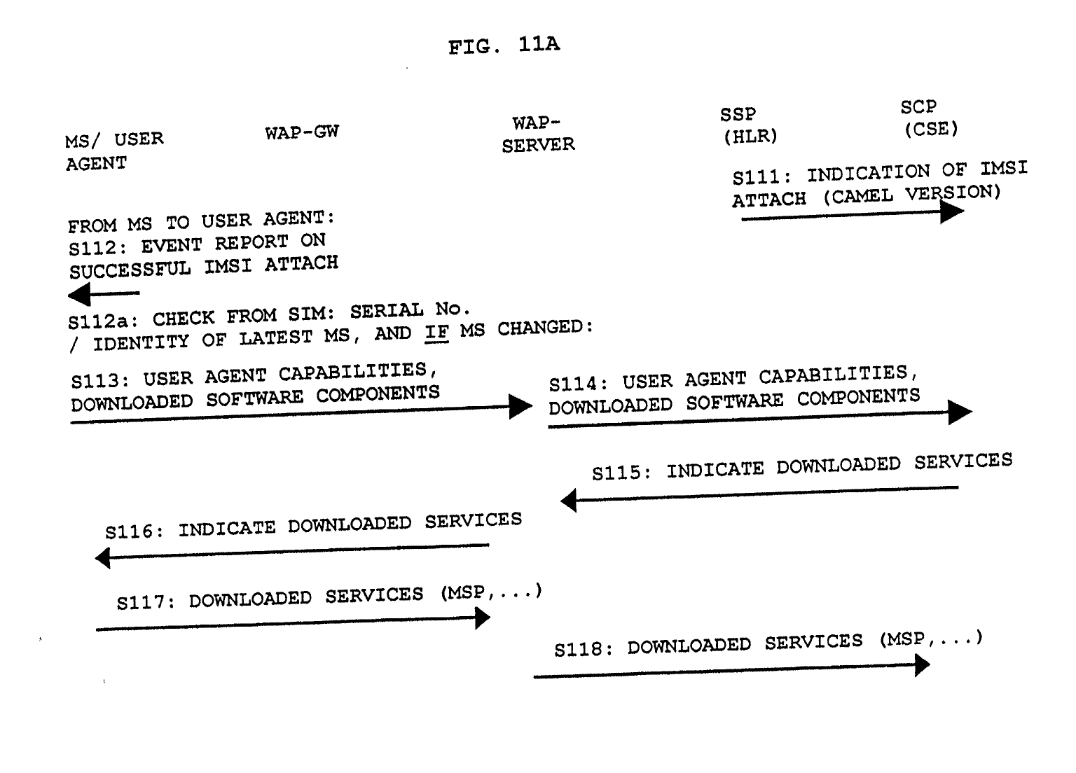

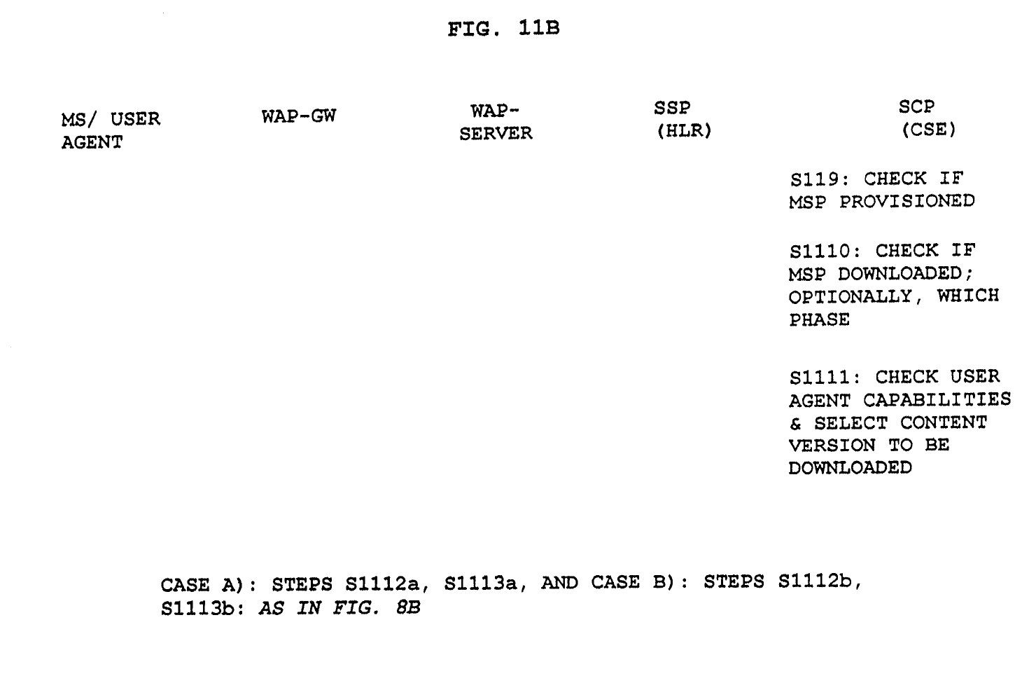

Now, with reference to FIGS. 11A and 11B, these figures together show a signaling scenario for the downloading of MSP menus according to a further embodiment.

Steps S111 and S112 are identical to steps S81 and S82 explained in connection with FIG. 8A earlier above, so that a repeated description thereof is omitted here. The determination of MSP version may also be based on other means than CAMEL version indication to the CSE. For example, it may be determined from the network and/or location identity possibly included in the MS.

In a subsequent step S112a, at the mobile station terminal/user agent side it is checked preferably from the subscriber identity module SIM, whether the identity of the latest mobile equipment has changed. Such an identity may be checked, for example, by referring to the serial number stored in the SIM. Stated in other words, at step S112a a check is performed to obtain an information as to whether the terminal has changed since the latest power on with the same subscription.

If the identity of the mobile station has changed, the signaling continues with the steps S113 to S1113.

In step S113, the user agent capabilities are forwarded from the MS/user agent via the WAP-server to the CSE (step S114. This is effected since the CSE inquires information on downloaded services. IN an alternative embodiment, the CSE is indicated by the MS/user agent automatically the downloaded services/software (and/or control instruction) components. The CSE in response thereto returns an indication as to the downloaded services (step S115) via the WAP-server to the MS/user agent (step S116). Information on the downloaded services is thereafter transmitted from the MS/user agent (step S117) to the WAP server and from there (step S118) to the CSE.

At the CAMEL Service Environment CSE, then the following steps are carried out, as shown in FIG. 11B.

In step S119, as shown in FIG. 11B, it is checked whether MSP is provisioned. At step S110 it is checked, whether MSP is downloaded, and possibly also, which MSP phase is downloaded. At step S111 the user agent capabilities are checked and the content version to be downloaded is selected.

The subsequent steps S1112a, S1113a (in a case A) as well as steps S1112b, S1113b (in a case B) are identical to those illustrated and explained in detail in connection with FIG. 8B, so that a repeated description thereof is omitted here.

The described embodiment is advantageous if there is an automatic client capability report implemented from the WAP user agent/MexE environment (mentioned above) to the WAP server/MexE server.

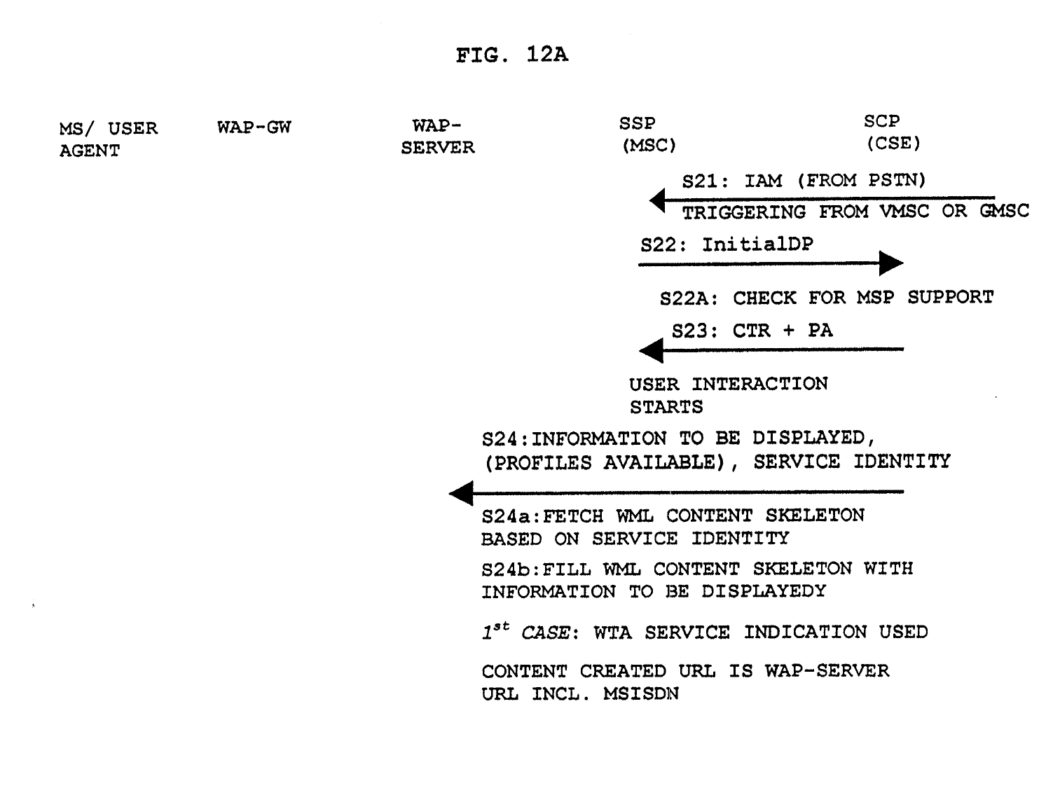

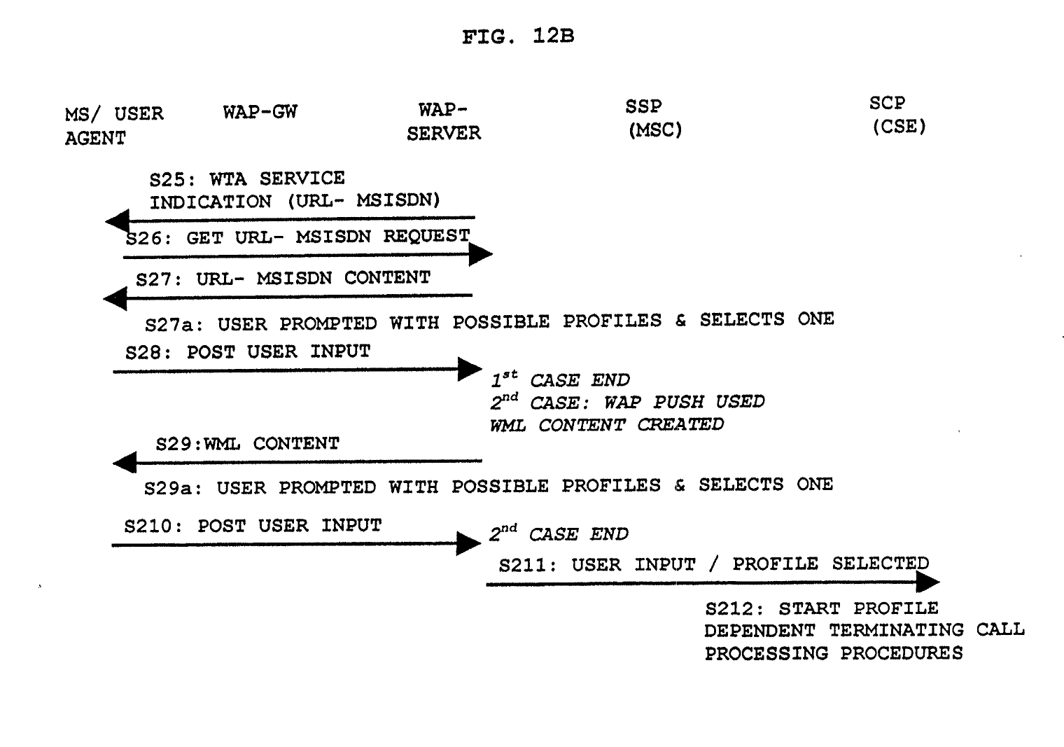

Still further, FIGS. 12A and 12B together illustrate a signaling scenario for a subscriber profile selection in case of an incoming call using WTA.

In this case, the called party is identified using only one MSISDN, if the profile selection is to be applied. That is, the MSISDN does not specify the profile for a respective terminated call, while normally, there are different MSISDNs for different profiles. The profile selection service is triggered from a GMSC T-BSCM (not shown). The IN service issues a WTA service indication to the mobile station. The user is then prompted to select the profile which should be used for the terminating (incoming) call. The user may also be presented some information related to the calling party, on the amount and price of calls received for each profile and so on. The selection is passed from the WTA server (WAP server) to the IN service, i.e. the IN service entity. The IN service entity then selects the profile in accordance with the multiple subscriber profiles functionality implementation.

This way of profile selection is advantageous in cases where the called party pays for incoming calls.

The above briefly described signaling is now set out in greater detail with reference to FIGS. 12A and 12B, which show a signaling scenario in connection with a mobile originated call in case a service user interface has not been downloaded to the terminal.

In FIG. 12A, in an initial step S21, an initial access message IAM is transmitted from the PSTN (not shown) (i.e., a terminal in the PSTN) to the MSC as a SSP. Alternatively, also a corresponding triggering signal could be received from a visited MSC, i.e., a VMSC or a GMSC. The MSC transfers this, in a step S22, in an InitialDP message and/or operation (InitialDp representing a request for instructing to complete a call) to the service control point SCP such as a CAMEL service environment CSE. The CSE checks in step S22A whether MSP is supported. Also, the CSE, in response thereto forwards in a step S23 a Connect to Resource CTR and play announcement PA message/command to the MSC, since the user must be alerted (with in-band announcement for corresponding notification) for subsequent interaction, and also call set-up timer means (not shown) in a terminal device MS have to be prevented from expiring.

Thereafter, user interaction starts. Namely, in a step S24, information to be displayed (e.g., the profiles available) as well as a service identity is forwarded from the SCE to the associated WAP server. In step S24a, based on the service identity, a WML content skeleton is fetched, which WML content skeleton, in a following step S24b, is filled with information to be displayed. It is to be noted that the WAP server stores such WML skeletons per each service.

At this stage of the procedure, two cases have to be distinguished.

A first case is a case in which a WTA service indication is used. This means that a content created URL is a WAP server URL including a terminal (e.g. telephone) number MSISDN. Then, in step S25 (FIG. 12B) a WTA service indication in form of an URL-MSISDN is forwarded from the WAP server to the user agent. In response thereto, in step S26, the user agent replies to the WAP server by transmitting a “GET URLMSISDN request”, so that upon receipt thereof at the WAP server, the WAP server transmits, step S27, the URL-MSISDN content to the user agent. Subsequently, in a step S27a, the user is prompted with possible profile identities to be selected. The profile identities may be translated from, e.g., numbers to names by MSP content. The user may then select one of the prompted MSP profiles and/or one of the MSP profile identities for the terminating call. This can be effected automatically and done by the MSP content without user assistance, e.g., based on a previous user input. The user may input such selection instructions/commands via the MMI which are collected or accumulated (not shown), and such a user input is, in a step S28, posted from the user agent to the WAP server. Then, the flow ends as regards this branch of the first case.

As a second case, a WAP push operation is used, i.e., a WML content is (already) created. In this case, after step S24 (i.e.S24b), the procedure continues with a step S29, in which the WML content is transferred from the WAP server to the user agent. Subsequently, in a step S29a, the user is prompted with possible profile identities to be selected. The profile identities may be translated from, e.g., numbers to names by MSP content. The user may then select one of the prompted MSP profiles and/or one of the MSP profile identities for the terminating call. This can be effected automatic and done by the MSP content without user assistance, e.g., based on a previous user input. As a result, in a step S210 the thus entered and accumulated user input (collected as described before in connection with the first case) is posted from the user agent to the WAP server and the branch of the second case is terminated.

Irrespective of whether the first or second case is present, after the respective steps are completed, the flow continues with a step S211. In step S211, the user input representing the selected profile is transmitted from the WAP server to the service control point SCP (e.g., a CSE). The CSE in turn starts terminating call processing procedures dependent on the selected profile.

As described herein before, the present invention proposes a method for providing a user interface between a terminal device and a communication network for configuring intelligent network services, said network comprising a service control entity (SCP, CSE) and a server entity communicating with each other via an interface, said service control entity being connected to at least one service switching device establishing communication via at least one access network with said terminal device, and said terminal device being provided with a browsing means adapted to communicate with a user of said terminal device via a man machine interface means, and adapted to communicate with said server entity, the method comprising the steps of: creating a content which constitutes a user interface for the control of a multiple subscriber profiles (MSP) feature; user interacting with the content; and modifying the state of the subscriber profiles in accordance with said user interaction.

It should be understood that the above description and accompanying figures are merely intended to illustrate the present invention by way of example only. The preferred embodiments of the present invention may thus vary within the scope of the attached claims.

1. A method for providing a user interface between a terminal device (MS) and a communication network (IN-NW) for configuring intelligent network services, said network (IN-NW) comprising
a service control entity (SCP, CSE) and a server entity (WAP- or WTASERVER) communicating with each other via an interface (WAP-I/F),
said service control entity being connected to at least one service switching device (SSP, MSC, HLR, VLR) establishing communication via at least one access network (RAN, BSS) with said terminal device (MS), and
said terminal device (MS) being provided with a browsing means (WAP-UA) adapted to communicate with a user of said terminal device via a man machine interface means (MMI), and adapted to communicate with said server entity, the method comprising the steps of:
creating a content which constitutes a user interface for the control of a multiple subscriber profiles (MSP) feature;
user interacting (S91, S92) with the content in that a user selects to modify supplementary service data;
determining (S93), at the browsing means (UA), which profile type is determined, wherein
if the profile is determined to be intelligent network based (SECONDARY), supplementary service information is communicated (S94-S96) via said server entity (WAP-Server) to said service control entity (SCP, CSE), whereas
if the profile is standard supplementary service based (PRIMARY), a request for supplementary service registration is forwarded from the browsing means (UA) to the terminal device (MS); and a command to register the supplementary service data is forwarded from the terminal device (MS) via a first service switching device (MSC/VLR) to a second service switching device (HLR), and
modifying the state of the subscriber profiles in accordance with said user interaction.

2. A method according to claim 1, wherein said states of the subscriber profiles comprises the identity of the profile designated as the registered profile, and/or service states, and/or profiles selected for incoming or outgoing calls, and/or the execution states of each service.

3. A method according to claim 1, wherein the modifying the subscriber profiles state includes the selection of the profile to be used for an outgoing call.

4. A method according to claim 1, wherein the modifying the subscriber profiles state includes the selection of the profile to be used for an incoming call.

5. A method according to claim 1, wherein said services states comprise service activity/inactivity and/or service parameters for each service.

6. A method according to claim 1, wherein said content is loaded into said terminal device (MS) in response to a predetermined event.

7. A method according to claim 6, wherein said predetermined event is an IMSI attach, and/or a location updating, and/or a switching on of a new terminal for the user, and/or a subscriber profile registration request, and/or a supplementary service activation I deactivation request, and/or a terminal device originated call set-up request, and/or a terminal device terminated call set-up request.

8. A method according to claim 6, wherein said loading is effected from a subscriber identity module (SIM) to said terminal device mobile equipment part (ME).

9. A method according to claim 6, wherein said loading of said content is effected from a network element (WAP-SERVER) to said terminal device mobile equipment part (ME).

10. A method according to claim 6, wherein said content is cached in said terminal device for later events.

11. A method according to claim 2, wherein said registered profile within the subscriber profiles state is maintained in the service control entity.

12. A method according to claim 11, wherein the selection of said registered profile is communicated to the service control entity by said browsing means.

13. A method according to claim 12, wherein the selection of said registered profile is communicated to the service control entity by the content issuing a USSD or SMS message to said network, the network communicating the registered profile to the service control entity.

14. A method according to claim 12, wherein the selection of said registered profile is communicated to the service control entity by the content issuing a WSP/HTTP post method (wireless session protocol/hypertext transfer protocol) to said network, the network communicating the registered profile to the service control entity.

15. A method according to claim 2, wherein said services states within the subscriber profiles state are maintained in the service control entity.

16. A method according to claim 2, wherein said services states within the subscriber profiles state are maintained partly in the service control entity and partly in the GSM registers (HLR, VLR).

17. A method according to claim 15, wherein a change in said services states is communicated to the service control entity by said browsing means.

18. A method according to claim 17, wherein a change in said services state is communicated to the service control entity by the content issuing a USSD or SMS message to said network, the network communicating the registered profile to the service control entity.

19. A method according to claim 17, wherein a change in said services state is communicated to the service control entity by the content issuing a WSP/HTTP post method (wireless session protocol/hypertext transfer protocol) to said network, the network communicating the registered profile to the service control entity.

20. A method according to claim 1, wherein the selection of the subscriber profile to be used for a terminated call is performed by issuing a content push to said browser means; user interacting with the content; selected subscriber profile indicated to said server entity.

21. A method according to claim 20, wherein the selection of the profile to be used for a terminated call is prompted from the user when the calling party dials a number not explicitly indicating the subscriber profile for the incoming call.

22. A method according to claim 1, wherein the modifying of the state of the subscriber profiles includes the control of the execution of each service.

23. A method according to claim 6, wherein first the capabilities of the said terminal device (MS) and/or user agent capabilities are indicated to said server entity; the said content is selected on the said server entity based on the said capabilities; the said selected content is downloaded to the said terminal device (MS).

24. A method according to claim 23, wherein the capabilities of the said terminal device (MS) and/or user agent capabilities are indicated to said server entity if the mobile equipment part (ME) of the said terminal device has changed since the latest power off of the said terminal device (MS).

25. A method according to claim 23, wherein first said content is downloaded to said terminal device (MS), if it is discovered that such content is not already stored in said terminal device (MS).

26. A method according to claim 25, wherein information on the downloaded services is inquired from said terminal device (MS) and the downloading of said content is performed only if it is not among said downloaded services.

27. A method according to claim 1, wherein said content discovers the capabilities of said network when the user attaches to the network or enters the area of a new service switching device (MSC, SSP).

28. A method according to claim 27, wherein said content modifies the said user interface for the control of a multiple subscriber profiles feature in accordance with said capabilities of said network.

29. A method according to claim 27, wherein said capabilities of the said network is the Camel feature version supported in said current service switching device (MSC, SSP).

30. A method according to claim 8, wherein the capabilities of the said terminal device (MS) and/or browsing means are checked and compared to the capability requirements of said content before said loading; and if the capability requirements are not satisfying, downloading said content from said network.

31. A system for providing a user interface between a terminal device (MS) and a communication network (IN-NW) for configuring intelligent network services, said system being adapted to operate according to the method according to claim 1.
